(19) United States
(12) Patent Application Publication
(10) Pub. No.: US 2007/0206004 A1
(43) Pub. Date: Sep. 6, 2007

(54) IMAGE-SIGNAL ADAPTER WHICH RECEIVES ELECTRIC POWER FROM A COMPUTER

(76) Inventor: Feng-Lin Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/681,733

(22) Filed: Mar. 2, 2007

(30) Foreign Application Priority Data
Mar. 6, 2006 (TW) 095107384

(51) Int. Cl. G06T 15/00

(52) U.S. Cl. 345/419

(57) ABSTRACT

An image-signal adapter includes an image signal input interface, a plurality of image signal output interfaces and a circuit board. When the image signal input interface is coupled to a computer, the circuit board of the image-signal adapter receives electric power from the computer.

### BACKGROUND OF THE INVENTION

1. Field of the Invention

The present invention is related to an image-signal adapter, and more particularly, to an image-signal adapter powered by a computer.

2. Description of the Prior Art

Generally, a VGA display card has an image-signal output port that is used to only connect to a display device for optimizing display quality. However, if two or more display devices are coupled to one image-signal output port, the impedance between the VGA display card and the display devices may mismatch so that the images displayed on the devices could be incorrect.

In order to overcome the problem of impedance mismatch, more display cards are plugged in the computer. Therefore, each of the display devices can be coupled to a corresponding one of the display cards to avoid displaying incorrect images. Please refer to FIG. 1, which is a schematic diagram of a computer 1 coupled to a plurality of display devices 14-16 according to the prior art. A plurality of display cards are installed in the computer 1. Each of the display cards has a corresponding image-signal adaptor 11-13 for connecting a corresponding one of the display devices 14-16. However, the display cards occupy physical space in the computer 1.

In addition, the prior art adopts amplifiers powered by an exterior power supply to match the impedance between the display card and the display devices to certify the displayed images. Please refer to FIG. 2, which is a schematic diagram of a computer 2 coupled to a plurality of display devices 14-16 via an amplifier 22. There is a single display card installed in the computer 2. An image-signal input interface 23 of the amplifier 22 is coupled to an image-signal adapter 21 of the computer 2. The image signals received from the image-signal adapter 21 are transmitted to a plurality of image-signal output interfaces 24-26 of the amplifier 22. The display devices 14-16 are coupled to the image-signal output interfaces 24-26 to receive the image signals. However, the amplifier 22 cannot operate unless a power plug 27 of the amplifier 22 is plugged into an outlet of an exterior power supply.

### SUMMARY OF THE INVENTION

The present invention discloses an image-signal adaptor. The image-signal adaptor comprises a housing, an image signal input interface positioned in the housing for receiving image signals, and a circuit board positioned in the housing having an impedance matching circuit coupled to the image signal input interface for amplifying received image signals and a power terminal for receiving electric energy from a computer when the image signal input interface is coupled to the computer.

The present invention also discloses a circuit board powered by a computer for amplifying image signals. The circuit board comprises at least an image input terminal for receiving image signals, a first impedance matching circuit coupled to the image input terminal for amplifying received image signals, a voltage buffer for stabilizing quality of image control signals of received images signals, a power terminal coupled to the first impedance matching circuit and the voltage buffer for providing electric energy to the first impedance matching circuit and the voltage buffer, and a plurality of image signal output terminals coupled to the first impedance matching circuit for outputting image signals. The power terminal is coupled to a power line of an image output port of the computer to receive electric energy from the power line.

The present invention also discloses a circuit board powered by a USB port for amplifying image signals. The circuit board comprises at least an image input terminal for receiving image signals, a first impedance matching circuit coupled to the image input terminal for amplifying received image signals, a voltage buffer for stabilizing quality of image control signals of received images signals, a power terminal coupled to the first impedance matching circuit and the voltage buffer for providing electric energy to the first impedance matching circuit and the voltage buffer, and a plurality of image signal output terminals coupled to the first impedance matching circuit for outputting image signals. When the power terminal is coupled to a power line of the USB port, the power terminal receives electric energy from the power line.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a computer coupled to a plurality of display devices according to the prior art.

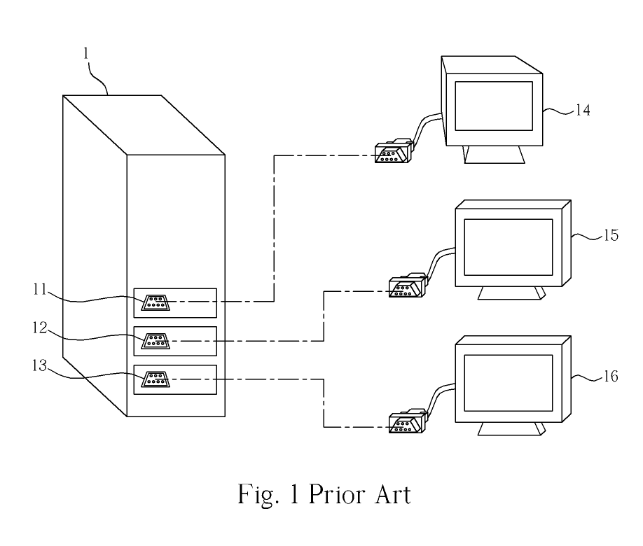

FIG. 2 is a schematic diagram of a computer coupled to a plurality of display devices via an amplifier.

FIG. 3 is a schematic diagram of an image-signal adapter according to the present invention.

FIG. 4 is schematic diagram of a second embodiment image-signal adapter according to the present invention.

FIG. 5 is a circuit diagram of a circuit board of the image-signal adapter shown in FIG. 4.

FIG. 6 is a circuit diagram of a circuit board of the image-signal adapter shown in FIG. 3.

### DETAILED DESCRIPTION

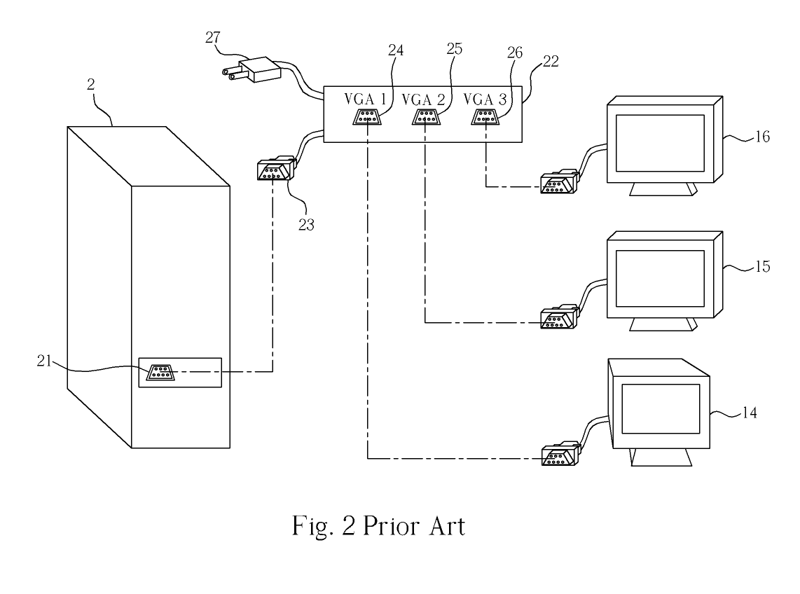

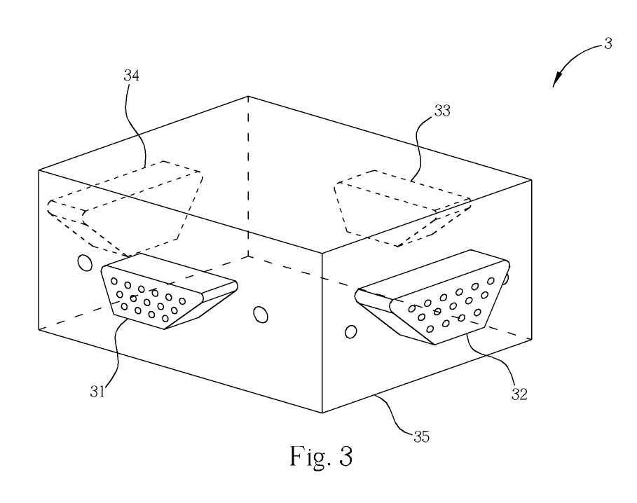

Please refer to FIG. 3, which is a schematic diagram of an image-signal adapter 3 according to the present invention. The image signal adapter 3 comprises an image-signal input interface 31 and a plurality of image-signal output interfaces 32-34. The image-signal input interface 31 and the image-signal output interfaces 32-34 are positioned on the different sides of the housing 35 of the image-signal adapter 3. The image-signal input interface 31 can be coupled to the image-signal adapter 21 shown in FIG. 2 to receive image signals. Unlike the amplifier 22 shown in FIG. 2, the image-signal adapter 3 receives electric power from the power line of the image-signal adapter 21 of the computer 2. Therefore, it is unnecessary to connect the image-signal adapter 3 with any outlet of an exterior power supply.

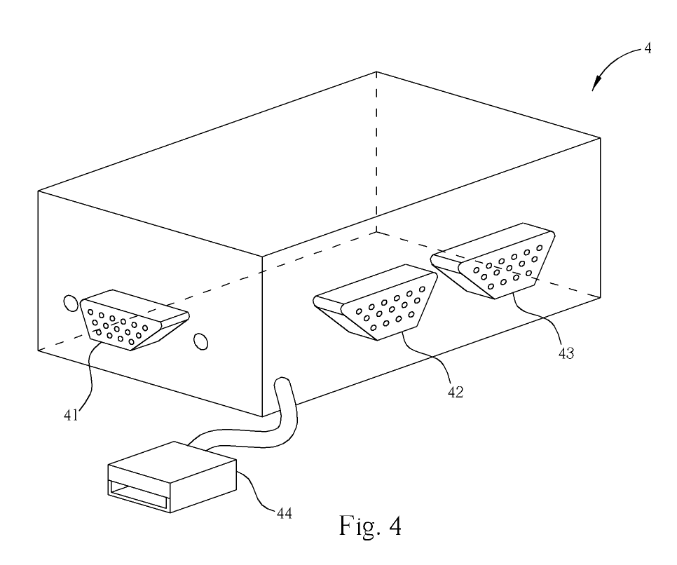

Please refer to FIG. 4, which is schematic diagram of a second embodiment image-signal adapter 4 according to the present invention. The image-signal adapter 4 comprises an image-signal input interface 41, a plurality of image-signal output interfaces 42-43, and an universal serial bus (USB) plug 44. The image-signal adapter 4 is capable of receiving electric power not only from the power line of the image-signal adapter 21 of the computer 2 but also from the USB plug 44 connected with a USB port of the computer 2. Therefore, the image-signal adapter 4 receives electric power from the computer via the USB plug 44 without connecting to any outlet of an exterior power supply.

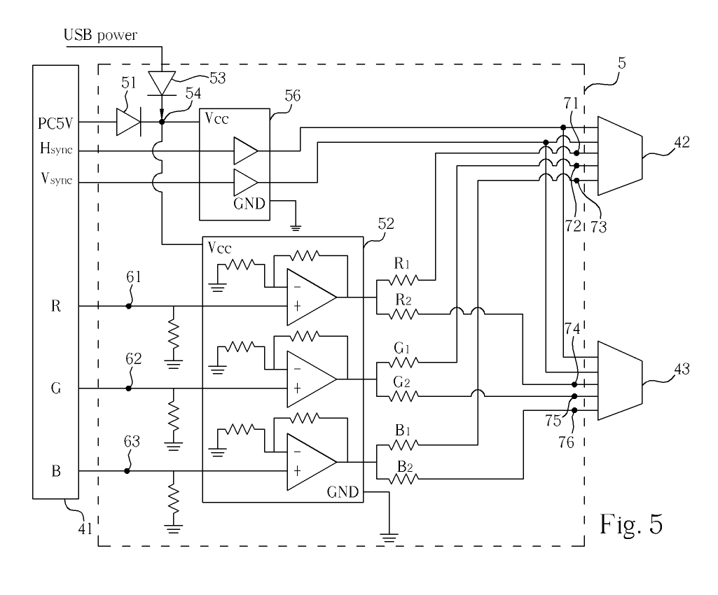

Please refer to FIGS. 4 and 5. FIG. 5 is a circuit diagram of a circuit board 5 of the image-signal adapter 4. The circuit board 5 comprises an impedance matching circuit, a voltage source terminal 54, and a voltage buffer 56. The impedance matching circuit comprises an amplifying circuit 52 and resistors R1, R2, G1, G2, B1, and B2. The voltage buffer 56 stabilizes the quality of a horizontal synchronization signal Hsync and a vertical synchronization signal Vsync received form the image-signal input interface 41 and then outputs the horizontal synchronization signal Hsync and the vertical synchronization signal Vsync to the image-signal output interfaces 42-43. Since the image-signal adapter 4 has two image-signal output interfaces 42-43, in order to avoid impedance mismatch, the image-signals received from the image-signal input interface 41 are amplified by the impedance matching circuit. Therefore, the image signals inputted from the image-signal input terminals 61-63 are amplified by the impedance matching circuit and then transmitted to the image-signal output interfaces 42-43 via the image-signal output terminals 71-76. The image signals transmitted to the image-signal output interfaces 42-43, hence, are correct. The circuit board 5 is capable of receiving electric power from the power line of the image-signal adapter 21 of the computer 2 or from the power line of the USB port of the computer 2 via the USB plug 44. In addition, a diode 51 is positioned between the power line of the image-signal adapter 21 of the computer 2 and the voltage source terminal 54. Another diode 53 is positioned between the power line of the USB port and the voltage source terminal 54. If the circuit board 5 is powered by the power line of the USB port, the diode 51 stops the current from flowing to the power line of the image-signal adapter 21. On the other hand, if the circuit board 5 is powered by the power line of the image-signal adapter 21, the diode 53 stops the current from flowing to the power line of the USB port.

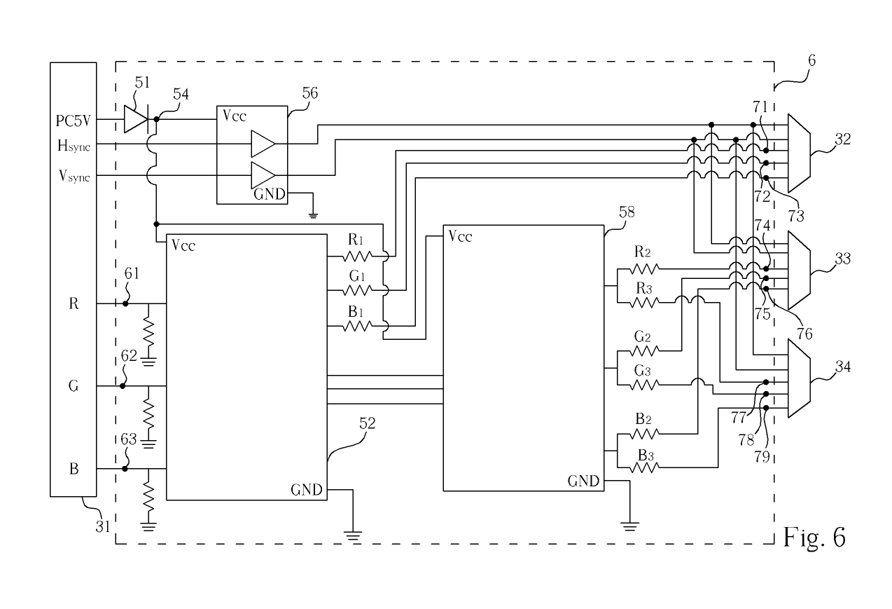

Please refer FIGS. 3 and 6. FIG. 6 is a circuit diagram of a circuit board 6 of the image-signal adapter 3. Since the image-signal adapter 3 has three image-signal output interfaces 32-34, in order to avoid impedance mismatch, the circuit board 6 comprises two impedance matching circuits. One of the two impedance matching circuits comprises an amplifying circuit 52 and resistors R1, R2, and G1, and the other one impedance matching circuit comprises an amplifying circuit 58, and resistors R2, R3, G2, G3, B2, and B3. The amplifying circuit 52 transmits image signals to three image-signal output terminals 71-73 and the amplifying circuit 58. The amplifying circuit 58 amplifies the image signals received from the amplifying circuit 52 and outputs the amplified image signals to six image-signal output terminals 74-79 that are coupled to the two image-signal output interfaces 33 and 34. The circuit board 6 is powered by the power line of the image-signal adapter 21 of the computer 2. In addition, if the image-signal adapter 3 comprises any USB plug, the circuit board 6 also can receive electric power from the USB port of the computer 2 via the USB plug.

In contrast with the prior art, the present invention provides an image-signal adaptor and related circuit boards powered by a power line of an image-signal port of a computer or by a power line of a USB port. Therefore, the image-signal adaptor does not need to connect with any outlet of an exterior power supply. In addition, the image-signal adapter comprises one or more impedance matching circuits to overcome impedance mismatch between one image-signal output port and display devices. The number of the impedance matching circuits can be increased according to the number of the display devices connected with the image-signal adapter to ensure the quality of the images displayed on the display devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image-signal adaptor comprising:
a housing;
an image signal input interface positioned in the housing for receiving image signals; and
a circuit board positioned in the housing having an impedance matching circuit coupled to the image signal input interface for amplifying received image signals and a power terminal for receiving electric energy from a computer when the image signal input interface is coupled to the computer.

2. The image-signal adaptor of claim 1 wherein the image signal input interface comprises a power input terminal coupled to the power terminal of the circuit board for connecting with the power terminal and a power line of an image output port of the computer.

3. The image-signal adaptor of claim 2 further comprising a USB socket formed on the housing and coupled to the power terminal of the circuit board for connecting with the power terminal and a power line of a USB port of the computer.

4. The image-signal adaptor of claim 1 further comprising a USB socket formed on the housing and coupled to the power terminal of the circuit board for connecting with the power terminal and a power line of a USB port of the computer.

5. The image-signal adaptor of claim 1 further comprising a plurality of image signal output interfaces positioned on the housing and coupled to an output terminal of the impedance matching circuit of the circuit board for passing image signals received from the impedance matching circuit.

6. The image-signal adaptor of claim 5 wherein the image signal output interfaces are positioned on different sides of the housing.

7. A circuit board powered by a computer for amplifying image signals, the circuit board comprising:
at least an image input terminal for receiving image signals;
a first impedance matching circuit coupled to the image input terminal for amplifying received image signals;
a voltage buffer for stabilizing quality of image control signals of received images signals;
a power terminal coupled to the first impedance matching circuit and the voltage buffer for providing electric energy to the first impedance matching circuit and the voltage buffer; and
a plurality of image signal output terminals coupled to the first impedance matching circuit for outputting image signals;
wherein the power terminal is coupled to a power line of an image output port of the computer to receive electric energy from the power line.

8. The circuit board of claim 7 wherein the power terminal is coupled to a power line of a USB port of the computer to receive electric energy from the power line of the USB port.

9. The circuit board of claim 8 further comprising a diode having a negative electrode coupled to the power terminal for receiving electric energy from the power line of the USB port.

10. The circuit board of claim 7 further comprising a second impedance matching circuit coupled to the power terminal and the first impedance matching circuit for amplifying image signals received from the first impedance matching circuit.

11. The circuit board of claim 10 wherein the image signal output terminals are coupled to the second impedance matching circuit for outputting image signals.

12. The circuit board of claim 7 further comprising a diode having a negative electrode coupled to the power terminal for receiving electric energy from the power line of the image output port.

13. A circuit board powered by a USB port for amplifying image signals, the circuit board comprising:
at least an image input terminal for receiving image signals;
a first impedance matching circuit coupled to the image input terminal for amplifying received image signals;
a voltage buffer for stabilizing quality of image control signals of received images signals;
a power terminal coupled to the first impedance matching circuit and the voltage buffer for providing electric energy to the first impedance matching circuit and the voltage buffer; and
a plurality of image signal output terminals coupled to the first impedance matching circuit for outputting image signals;
wherein when the power terminal is coupled to a power line of the USB port, the power terminal receives electric energy from the power line.

14. The circuit board of claim 13 further comprising a second impedance matching circuit coupled to the power terminal and the first impedance matching circuit for amplifying image signals received from the first impedance matching circuit.

15. The circuit board of claim 14 wherein the image signal output terminals are coupled to the second impedance matching circuit for outputting image signals.

16. The circuit board of claim 13 further comprising a diode having a negative electrode coupled to the power terminal for receiving electric energy from the power line of the USB port.
